(19) United States
(12) Patent Application Publication
(10) Pub. No.: US 2025/0122933 A1
(43) Pub. Date: Apr. 17, 2025

(54) SYSTEM AND METHOD FOR CONTROLLING THE OPERATION OF AN AGRICULTURAL VEHICLE CONFIGURED TO TOW AN AGRICULTURAL IMPLEMENT

(71) Applicant: CNH Industrial America LLC, New Holland, PA (US)

(72) Inventors: Derek Thomas Jennen, Moorhead, MN (US); Aaron Francis Onken, Kindred, ND (US); Thomas Michael Curley, Detroit Lakes, MN (US); Nathan James Carlson, West Fargo, ND (US)

(21) Appl. No.: 18/484,537

(22) Filed: Oct. 11, 2023

(51) Int. Cl. F16H 61/02; A01B 76/00; B62D 49/06; F02D 41/02; F16H 59/50; F16H 59/66; F16H 61/16

(52) U.S. Cl. CPC F16H 61/0213; A01B 76/00; F02D 41/021; F16H 59/50; F16H 61/16; B62D 49/06; F02D 2200/70; F16H 59/66; F16H 2059/663; F16H 2061/0234; F16H 2061/166

(57) ABSTRACT

A system for controlling the operation of an agricultural vehicle configured to tow an agricultural implement includes an engine coupled to a frame of the agricultural vehicle and a transmission operatively coupled to the engine. The system also includes a sensor configured to generate data indicative of a field surface incline forward of the agricultural vehicle relative to a direction of travel of the agricultural vehicle. Additionally, the system includes a computing system communicatively coupled to the sensor. The computing system is configured to determine a field surface incline parameter based on the data generated by the sensor. Furthermore, the computing system is configured to initiate an adjustment to an operation of at least one of the engine or the transmission based on the determined field surface parameter prior to engagement of the field surface incline.

### FIELD OF THE INVENTION

The present subject matter relates generally to agricultural vehicles and, more particularly, to systems and methods for controlling the operation of an agricultural vehicle configured to tow an agricultural implement.

### BACKGROUND OF THE INVENTION

Current agricultural vehicles, such as tractors, are configured to tow agricultural implements, such as tillage implements, across a field during agricultural operations. Tillage implements and other implements often include various ground-engaging tools, such as shanks and/or disk blades, for tilling or otherwise engaging the soil of a field. The various ground-engaging tools are typically adjustable relative to the implement frame to adjust the penetration depth of the ground-engaging tools within the soil. Increased penetration depth combined with the weight/frictional forces of the agricultural implement create an agricultural implement draft load on the agricultural vehicle. As the agricultural vehicle and the agricultural implement engage varying terrain of a given field surface, particularly hill inclines, the draft load acting on the agricultural vehicle may cause a decrease in momentum of the agricultural vehicle/implement combination. When the draft load and/or the hill incline are great enough, the decrease in momentum disrupts the agricultural vehicle operations by, for example, stalling the agricultural vehicle, which requires the agricultural vehicle operator to raise the agricultural implement frame to reduce the draft load.

Accordingly, an improved system for controlling the operation of an agricultural vehicle configured to tow an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural vehicle configured to tow an agricultural implement. The agricultural vehicle includes a frame, an engine coupled to the frame, and a transmission operatively coupled to the engine. Additionally, the agricultural vehicle includes a sensor configured to generate data indicative of a field surface incline forward of the agricultural vehicle relative to a direction of travel of the agricultural vehicle. Furthermore, the agricultural vehicle includes a computing system communicatively coupled to the sensor. The computing system is configured to determine a field surface incline parameter based on the data generated by the sensor. Moreover, the computing system is configured to initiate an adjustment to an operation of at least one of the engine or the transmission based on the determined field surface incline parameter prior to engagement of the field surface incline.

In another aspect, the present subject matter is directed to a system for controlling an operation of an agricultural vehicle configured to tow an agricultural implement. The system includes an engine coupled to a frame of the agricultural vehicle and a transmission operatively coupled to the engine. Additionally, the system includes a sensor configured to generate data indicative of the field surface incline forward of the agricultural vehicle relative to a direction of travel of the agricultural vehicle. Furthermore, the system includes a computing system communicatively coupled to the sensor. The computing system is configured to determine a field surface incline parameter based on the data generated by the sensor. Moreover, the computing system is configured to initiate an adjustment to an operation of at least one of the engine or the transmission based on the determined field surface incline parameter prior to engagement of the field surface incline.

In a further aspect, the present subject matter is directed to a method for controlling an operation of an agricultural vehicle configured to tow an agricultural implement. The method includes determining, with a computing system, a field surface incline parameter based on data generated by a sensor configured to generate data indicative of a field surface incline forward of the agricultural vehicle relative to a direction of travel of the agricultural vehicle. Additionally, the method includes initiating, with the computing system, an adjustment to an operation of at least one of an engine or a transmission of the agricultural vehicle based on the determined field surface incline parameter prior to engagement of the field surface incline.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural vehicle towing an agricultural implement in accordance with aspects of the present subject matter;

FIG. 2 illustrates a perspective view of the agricultural implement shown in FIG. 1;

FIG. 3 illustrates a schematic view of one embodiment of a system for controlling the operation of an agricultural in accordance with aspects of the present subject matter;

FIG. 4 illustrates a flow diagram of one embodiment of control logic for controlling the operation of an agricultural vehicle accordance with aspects of the present subject matter; and

FIG. 5 illustrates a flow diagram of one embodiment of a method for controlling the operation of an agricultural vehicle in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the operation of an agricultural vehicle configured to tow an agricultural implement. As will be described below, the agricultural vehicle includes an engine and a transmission operatively coupled to the engine. Additionally, an agricultural implement is coupled to and towed by the agricultural vehicle. In this respect, as the operation of the engine and/or transmission is adjusted, for example, to increase the engine speed, the agricultural vehicle and agricultural implement ground speed is correspondingly increased.

In several embodiments, a computing system of the disclosed system is configured to perform various functions for controlling the operation of the agricultural vehicle configured to tow an agricultural implement prior to the agricultural vehicle and/or agricultural implement engaging a hill/steep terrain of a field surface. More specifically, the computing system is configured to use data generated by various sensors and/or other components of the agricultural vehicle (e.g., engine) to determine, for example, a field surface incline parameter, such as an incline slope, a draft load of the agricultural implement, and/or a current and required operational status of the agricultural vehicle, and control the agricultural vehicle to, for example, avoid a stall of the agricultural vehicle while engaging the hill/steep terrain and/or maintain the agricultural vehicle speed after the engaging the hill/steep terrain.

Typically, when the agricultural vehicle and the agricultural implement are driving up an incline, the draft load created by the combination of the agricultural implement weight and the penetration depth of the various ground-engaging tools of the agricultural implement decrease the momentum of the agricultural vehicle and often lead to a stall of the agricultural vehicle. The system and method described herein allow the computing system to use data generated by various sensors to predict necessary adjustments that need to be made to the operational status (e.g., engine speed) of the agricultural vehicle based on the draft load of the agricultural implement and the field surface incline and then make those adjustments prior to the agricultural implement and/or agricultural vehicle engaging the incline in order to prevent the agricultural vehicle from stalling.

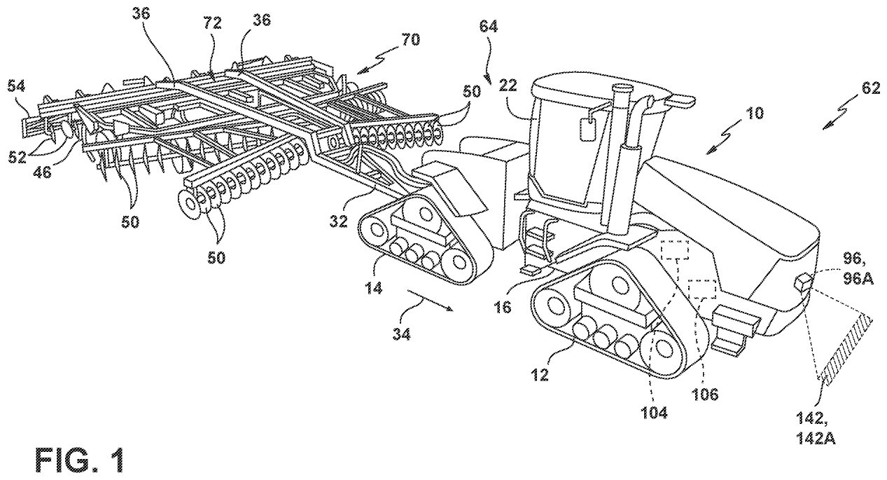

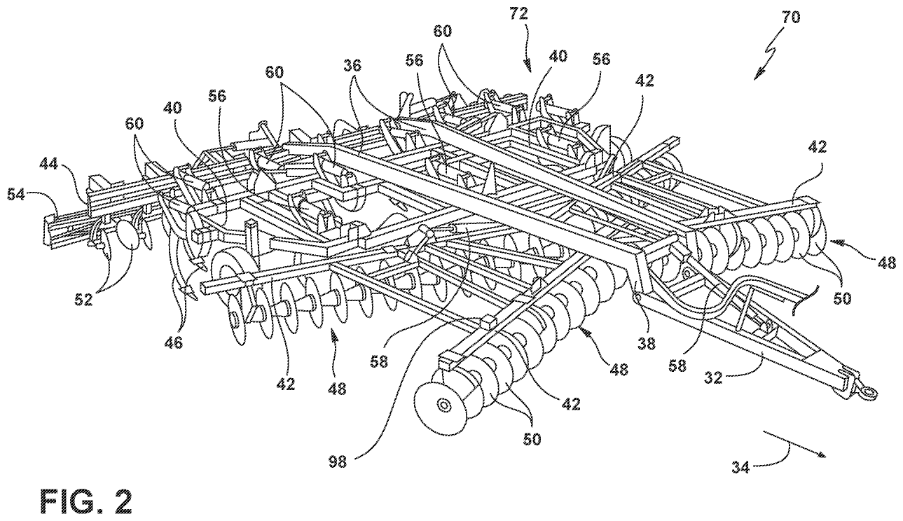

Referring now to drawings, FIGS. 1 and 2 illustrate perspective views of one embodiment of an agricultural vehicle 10 and an associated agricultural implement 70 in accordance with aspects of the present subject matter. Specifically, FIG. 1 illustrates a perspective view of the agricultural vehicle 10 towing the agricultural implement 70 across a field in a travel direction (e.g., as indicated by arrow 34). Additionally, FIG. 2 illustrates a perspective view of the agricultural implement 70 shown in FIG. 1.

As shown, in the illustrated embodiment, the agricultural vehicle 10 is configured as an agricultural tractor and the agricultural implement 70 is configured as a tillage implement (e.g., a disk ripper). However, in other embodiments, the agricultural vehicle 10 may be configured as any other suitable type of agricultural vehicle. Similarly, in other embodiments, the agricultural implement 70 may be configured as any other suitable agricultural implement configured to be towed by an agricultural vehicle, such as a seed-planting implement (e.g., a seeder, a planter, a side dresser, etc.).

As particularly shown in FIG. 1, the agricultural vehicle 10 extends between a forward end 62 and an aft end 64 relative to the travel direction 34 of the agricultural vehicle 10. The agricultural vehicle 10 includes a pair of front track assemblies 12, a pair or rear track assemblies 14, and a frame or chassis 16 coupled to and supported by the track assemblies 12, 14. However, in other embodiments, the agricultural vehicle 10 may include wheels and tires (not shown) in addition to or in lieu of the track assemblies. Additionally, the agricultural vehicle 10 may include an engine 104 and a transmission 106 supported by the frame 16. An operator's cab 18 may be supported by a portion of the frame 16 and may house various input devices for permitting an operator to control the operation of one or more components of the agricultural vehicle 10 and/or one or more components of the agricultural implement 70.

Additionally, as shown in FIGS. 1 and 2, the agricultural implement 70 may generally include a carriage frame assembly 72 configured to be towed by the agricultural vehicle 10 via a pull hitch or tow bar 32 in the travel direction 34 of the agricultural vehicle/implement 10/70. In general, the carriage frame assembly 72 may support a plurality of ground-engaging tools, such as a plurality of shanks, disk blades, leveling blades, basket assemblies, tines, spikes, and/or the like. In several embodiments, the various ground-engaging tools may be configured to perform an agricultural operation, such as a tillage operation or any other suitable ground-engaging operation, across the field along which the agricultural implement 70 is being towed.

As particularly shown in FIG. 2, the carriage frame assembly 72 may include aft extending carrier frame members 36 coupled to the tow bar 32. In addition, reinforcing gusset plates 38 may be used to strengthen the connection between the tow bar 32 and the carrier frame members 36. In several embodiments, the carriage frame assembly 72 may generally support a central frame 40, a forward frame 42 positioned forward of the central frame 40 relative to the travel direction 34 of the agricultural vehicle/implement 10/70, and an aft frame 44 positioned aft of the central frame 40 relative to the travel direction 34 of the agricultural vehicle/implement 10/70. As shown, in one embodiment, the central frame 40 may correspond to a shank frame configured to support a plurality of ground-engaging shanks 46. In such an embodiment, the shanks 46 are configured to till or otherwise engage the soil as the agricultural implement 70 is towed across the field. However, in other embodiments, the central frame 40 may be configured to support any other suitable ground-engaging tools.

Additionally, as shown in FIG. 2, in one embodiment, the forward frame 42 may correspond to a disk frame configured to support various gangs or sets 48 of disk blades 50. Specifically, the disk blades 50 are spaced apart from each other along the length of the disk gang 48 and configured to rotate relative to the soil within the field as the agricultural implement 70 travels across the field in the travel direction 34. Furthermore, each disk blade 50 may include both a concave side (not shown) and a convex side (not shown). In addition, the various gangs 48 of disk blades 50 may be oriented at an angle relative to the travel direction 34 of the agricultural vehicle/implement 10/70 to promote more effective tilling of the soil. However, in other embodiments, the forward frame 42 may be configured to support any other suitable ground-engaging tools.

Moreover, like the central and forward frames 40, 42, the aft frame 44 may also be configured to support a plurality of ground-engaging tools. For instance, in the illustrated embodiment, the aft frame 44 is configured to support a plurality of leveling blades 52 and rolling (or crumbler) basket assemblies 54. However, in other embodiments, any other suitable ground-engaging tools may be coupled to and supported by the aft frame 44, such as a plurality of closing disk blades.

In addition, the agricultural implement 70 may also include any number of suitable ground-engaging tool actuators (e.g., hydraulic cylinders, electric linear actuators, etc.) for adjusting the relative positioning of, the penetration depth of, and/or the force being applied to the various ground-engaging tools 46, 50, 52, 54. For instance, the agricultural implement 70 may include one or more actuators 56 coupled to the central frame 40 for raising and/or lowering the central frame 40 relative to the ground, thereby allowing the penetration depth of and/or the force being applied to the shanks 46 to be adjusted. Similarly, the agricultural implement 70 may include one or more actuators 58 coupled to the forward frame 42 to adjust the positioning relative to the carriage frame assembly 72 of, the penetration depth of, and/or the force being applied to the disk blades 50. Moreover, the agricultural implement 70 may include one or more actuators 60 coupled to the aft frame 44 to allow the aft frame 44 to be moved relative to the central frame 40, thereby allowing the relevant operating parameters of the ground-engaging tools 52, 54 supported by the aft frame 44 (e.g., the force being applied to and/or the penetration depth of) to be adjusted.

As the agricultural implement 70 is towed by the agricultural vehicle 10 across the field surface, the agricultural implement 70 applies a draft load to the agricultural vehicle 10. The draft load applied to the agricultural vehicle 10 by the agricultural implement 70 may increase as the agricultural vehicle 10 and agricultural implement 70 travel across an incline in the field surface and/or as the penetration depth of the various ground-engaging tools 46, 50, 52, 54 increases.

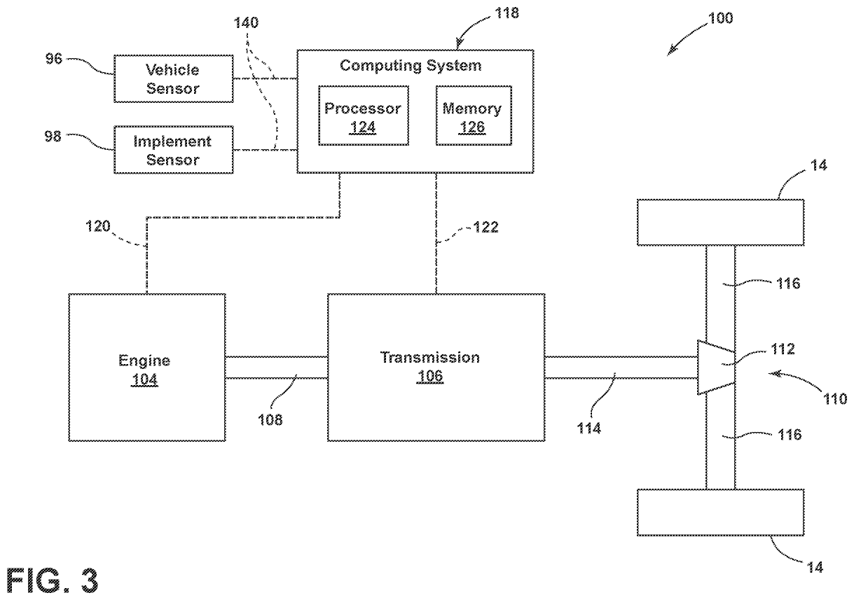

Moreover, the agricultural vehicle 10 and/or the agricultural implement 70 may include one or more sensors coupled thereto and/or supported thereon. For example, the agricultural vehicle 10 may include one or more vehicle sensors 96 coupled thereto and/or supported thereon. The vehicle sensor(s) 96 may be configured to generate data indicative of a field surface incline, such as a slope of an incline, forward of the agricultural vehicle 10 relative to the travel direction 34 of the agricultural vehicle 10. The data generated by the vehicle sensor(s) 96 may be used by a computing system 118 (FIG. 3) to determine whether, and to what degree, to adjust an operation of the engine 104 and/or the transmission 106 of the agricultural vehicle 10.

In several embodiments, the vehicle sensor(s) 96 is configured as a vision-based sensor(s) configured to depict a portion of the field present within its field of view 104 as the agricultural vehicle/implement 10/70 moves across the field in the travel direction 34. As such, the vehicle sensor(s) 96 may capture image data and and/or other vision-based data indicative of a field surface incline prior to or as the agricultural vehicle 10 moves along the field surface incline.

In general, the vehicle sensor(s) 96 may correspond to any suitable sensing devices configured to generate image data or image-like data depicting the surface of the field. Specifically, in several embodiments, the vehicle sensor(s) 96 may correspond to a suitable camera(s) configured to capture images of, for example, the topography of the field present within the field of view 142, thereby allowing parameters, such as slope, of the field surface inclines present on the field to be determined by analyzing the content of each image. For instance, in a particular embodiment, each vehicle sensor 96 may correspond to a stereographic camera(s) having two or more lenses with a separate image sensor for each lens to allow the cameras to capture stereographic or three-dimensional images. Alternatively, the vehicle sensor(s) 96 may correspond to any other suitable devices for generating image data or image-like data, such as a monocular camera(s), a LiDAR device(s), a RADAR device(s), and/or the like.

The vehicle sensor(s) 96, when configured as a vision-based sensor(s), may be mounted at any suitable location(s) on the agricultural vehicle 10 that allows the vehicle sensor(s) 96 to generate image data indicative of a field surface incline forward of the agricultural vehicle 10 relative to the travel direction 34. For example, in the illustrated embodiment, a first imaging device 96A is mounted on the forward end 62 of the agricultural vehicle 10 such that the first imaging device 96A has a field of view 142A directed at a portion of the field forward of the agricultural vehicle 10.

However, it should be appreciated that the vehicle sensor(s) 96 described above may be any other suitable type of sensor configured to generate data indicative of a field surface incline forward of the agricultural vehicle 10 relative to the direction of travel 34, such as gyroscopes, proximity sensors, and/or the like. Furthermore, it should be appreciated that the vehicle sensor(s) 96 may be mounted and/or supported at any suitable location(s) on the agricultural vehicle 10 that allows the vehicle sensor(s) 96 to generate data indicative of a field surface incline.

Additionally, the agricultural implement 70 may include one or more implement sensors 98 coupled thereto and/or supported thereon. The implement sensor(s) 98 may be configured to generate data indicative of the draft load of the agricultural implement 70. The data generated by the implement sensor(s) 98 may be used by the computing system 118 (FIG. 3) to determine whether, and to what degree, to adjust an operation of the engine 104 and/or the transmission 106 of the agricultural vehicle 10.

In general, the implement sensor(s) 98 may correspond to any suitable sensing devices configured to measure the draft load of the agricultural implement 70. For example, in the implement sensor(s) 98 may be configured as a strain gauge(s), a hydraulic load cell(s), a pneumatic load cell(s), a capacitive load cell(s), a piezoelectric transducer(s), and/or the like. Furthermore, the implement sensor(s) 98 may be mounted at any suitable location(s) on the agricultural implement 70 and/or the agricultural vehicle 10 that allows the implement sensor(s) 98 to generate data indicative of the draft load of the agricultural implement 70. For example, in the illustrated embodiment, an implement sensor 98 is mounted on the forward frame 42 of the agricultural implement 70.

Additionally, it should be appreciated that the configurations of the agricultural vehicle 10 and the agricultural implement 70 described above and shown in FIGS. 1 and 2 are only provided to place the present subject matter in an exemplary field of use. Thus, the present subject matter may be readily adaptable to any manner of agricultural vehicle and/or agricultural implement configuration. For example, the agricultural implement 70 may be configured as a planting implement, a fertilizing implement, and/or any other suitable type of agricultural implement.

Referring now to FIG. 3, a schematic diagram of one embodiment of a system 100 for controlling the operation of an agricultural vehicle configured to tow an agricultural implement is illustrated in accordance with aspects of the present subject matter. For purposes of discussion, the system 100 will be described herein with reference to the agricultural vehicle 10 and agricultural implement 70 shown and described above with reference to FIGS. 1 and 2. However, it should be appreciated that, in general, the disclosed system 100 may be utilized to control the operation of any agricultural vehicle having any suitable vehicle configuration.

As shown, the system 100 includes the engine 104 and the transmission 106, which are suitable for transferring power to the track assemblies 12, 14 of the agricultural vehicle 10. The transmission 106 may be operably coupled to the engine 104 via one or more shafts 108 and may be configured to provide variably adjusted gear ratios for transferring engine power to the track assemblies 12, 14 via a drive axle assembly 110. As shown, the drive axle assembly 110 may include a differential 112 coupled to an output shaft 114 of the transmission 106 and one or more axle shafts 116 coupled to the differential 112 for transferring power to the track assemblies 12, 14.

As shown in FIG. 3, the system 100 may also include a computing system 118 configured to perform one or more computing functions. For example, the computing system 118 may be communicatively coupled to the vehicle sensor(s) 96 and/or the implement sensor(s) 98 via one or more communicative links 140 and thus configured to receive the data from the vehicle sensor(s) 96 indicative of the field surface incline and the data from the implement sensor(s) 98 indicative of the draft load of the agricultural implement 70. However, it should also be appreciated that the computing system 118 may be configured to receive data indicative of the field surface incline in other suitable manners. For example, the computing system 118 may receive predetermined data of the topography of the field surface, such as the location of the field surface incline. The predetermined data may be, for example, data from a field map generated during a previous agricultural operation.

Furthermore, the computing system 118 may be configured to determine a current operational status of the agricultural vehicle 10. For example, the computing system 118 may be communicatively coupled to one or more components of the engine 104 (e.g., an engine governor or engine control unit (ECU) (not shown)) via one or more communicative links 120 to control and/or monitor the current speed and/or torque output of the engine 104. As such, the computing system 118 may be configured to monitor a current speed of the output shaft 108 of the engine 104 for monitoring the current engine speed (e.g., in RPMs).

Moreover, the computing system 118 may be communicatively coupled to one or more transmission components of the transmission 106 via one or more communicative links 122 to control and/or monitor the current transmission output speed and/or the current axle speed. As such, the computing system 118 may be configured to monitor a current speed of the output shaft 114 of the transmission 106 for monitoring transmission output speed (e.g., in RPMs) and/or monitor a current speed of the drive axles 116 for monitoring the current axle speed.

Additionally, the computing system 118 may be configured to initiate an adjustment to the operation of one or more components of the agricultural vehicle 10, such as the engine 104 and/or the transmission 106. For example, the computing system 118 may be configured to send a required operational status to the engine 104 requesting that the engine 104 adjust the determined current operational status to the required operational status. In this respect, the computing system 118 may be configured to send a required engine speed to the engine 104 requesting that the engine 104 adjust the current engine speed to match the required engine speed. The engine 104 may then adjust the current engine speed as requested.

Similarly, the computing system 118 may be configured to send a required operational status to the transmission 106 requesting that the transmission 106 adjust the determined current operational status to the required operational status. In this respect, the computing system 118 may be configured to transmit suitable current commands via the communicative link 122 to one or more clutch valves (not shown) to control the engagement and disengagement of one or more clutches (not shown) of the transmission 106. As such, the computing system 118 may be configured to cause the transmission 106 to be upshifted or downshifted, as desired, to adjust the current gear ratio of the transmission 106 such that, for example, the current transmission output speed is adjusted to a required transmission output speed.

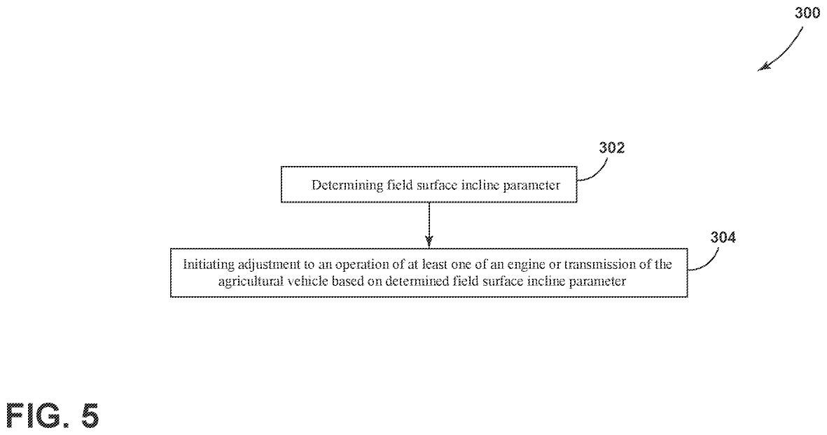

It should be appreciated that the computing system 118 may generally comprise any suitable processor-based device known in the art, such as one or more computing devices. Thus, in several embodiments, the computing system 118 may include one or more processor(s) 124 and associated memory 126 device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 126 of the computing system 118 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 126 may generally be configured to store suitable computer-readable instructions that, when implemented by the processor(s) 124, configure the computing system 118 to perform various computer-implemented functions, such as the method 300 described below with reference to FIG. 5. In addition, the memory 126 of the computing system 118 may also include various types of relevant data for performing the control functions described herein, such as by including all of the gear ratios of the transmission 106 stored therein. Moreover, the computing system 118 may also include various other suitable components, such as a communications circuit or module, one or more input/output channels, a data/control bus and/or the like.

It should also be appreciated that the computing system 118 may correspond to an existing computing system of the agricultural vehicle 10 (e.g., an existing engine and/or transmission controller) or the computing system 118 may correspond to a separate computing system. For instance, in one embodiment, the computing system 118 may form all or part of a separate plug-in module that may be installed within the agricultural vehicle 10 to allow for the disclosed system and method to be implemented without requiring additional software to be uploaded onto existing control devices of the vehicle 10.

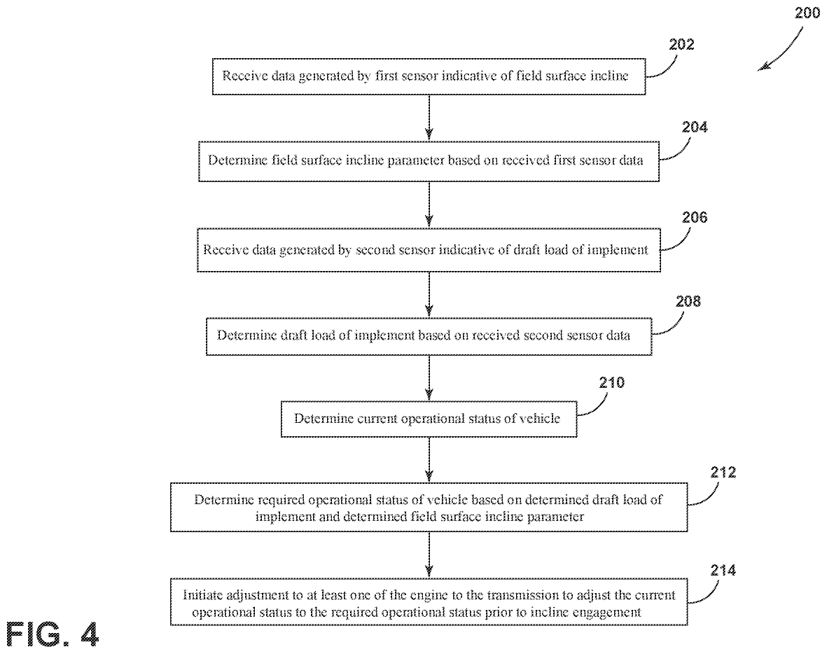

Referring now to FIG. 4, a flow diagram of one embodiment of control logic 200 that may be executed by the computing system 118 (or any other suitable computing system) for controlling the operation of an agricultural vehicle is illustrated in accordance with aspects of the present subject matter. In general, the control logic 200 will be described herein with reference to the system 100 described above with reference to FIG. 3. However, in other embodiments, the control logic 200 may be used in association with any other suitable system, application, and/or the like for controlling the operation of an agricultural vehicle.

As shown in FIG. 4, at (202), the control logic 200 includes receiving data generated by a first sensor indicative of a field surface incline forward of the agricultural vehicle relative to the direction of travel of the agricultural vehicle. As mentioned previously, the computing system 118 is communicatively coupled to the vehicle sensor(s) 96, which may correspond to the first sensor(s). As such, the computing system 118 is configured to receive data generated by the vehicle sensor(s) 96 indicative of the field surface incline forward of the agricultural vehicle 10 relative to the direction of travel 34 of the agricultural vehicle 10.

Moreover, as shown in FIG. 4, at (204), the control logic 200 includes determining a field surface incline parameter based on the data generated by the first sensor. As such, the computing system 118 is configured to determine the field surface incline parameter (e.g., slope of the incline) based on the data generated by the vehicle sensor(s) 96. For example, the computing system 118 may access a look-up table within its memory 126 that correlates the received data generated by the vehicle sensor(s) 96 to the corresponding field surface incline parameter(s).

Furthermore, as shown in FIG. 4, at (206), the control logic 200 includes receiving data generated by a second sensor indicative of a draft load of the agricultural implement. As mentioned previously, the computing system 118 is communicatively coupled to the implement sensor(s) 98, which may correspond to the second sensor(s). As such, the computing system 118 is configured to receive data generated by the implement sensor(s) 98 indicative of the draft load of the agricultural implement 70.

Additionally, as shown in FIG. 4, at (208), the control logic 200 includes determining a draft load of the agricultural implement based on the data generated by the second sensor. As mentioned previously, as the agricultural vehicle 10 and agricultural implement 70 travel across an incline in the field surface and/or as the penetration depth of the various ground-engaging tools 46, 50, 52, 54 of the agricultural implement 70 increase, the draft load of the agricultural implement 70 may increase. As such, the computing system 118 is configured to determine the draft load of the agricultural implement 70 based on the data generated by the implement sensor(s) 98. For example, prior to the agricultural implement 70 engaging the field surface incline, the computing system 118 may be configured to determine a current draft load of the agricultural implement 70 (e.g., the draft load of the agricultural implement 70 prior to the agricultural implement 70 engaging the field surface incline) based on the data received from the implement sensor(s) 98. Additionally, prior to the agricultural implement 70 engaging the field surface incline, the computing system 118 may be configured to determine a future draft load of the agricultural implement 70 (e.g., the draft load of the agricultural implement 70 once the agricultural implement 70 has engaged the field surface incline) based on the data received from the implement sensor(s) 98 and the vehicle sensor(s) 96. For example, the computing system 118 may access a look-up table within its memory 126 that correlates the current draft load of the agricultural implement 70 and the determined field surface incline parameter (e.g., slope) to the corresponding future draft load of the implement 70.

Moreover, as shown in FIG. 4, at (210), the control logic 200 includes determining a current operational status of the agricultural vehicle. As indicated above in reference to FIG. 3, the computing system 118 may be communicatively coupled to one or more components of the engine 104 and/or the transmission 106. As such, the computing system 118 may be configured to monitor a current operational status of the engine 104 (e.g., speed of the output shaft 108) and/or the transmission 106 (e.g., speed of the output shaft 114). Additionally, the computing system 118 may be configured to determine the current operational status of the agricultural vehicle 10 prior to the agricultural vehicle 10 and/or the agricultural implement 70 engaging the field surface incline.

Furthermore, as shown in FIG. 4, at (212), the control logic 200 includes determining a required operational status of the agricultural vehicle based on the determined draft load of the agricultural implement and the determined field surface incline parameter. As such, the computing system 118 may use data received from various sensors, such as the vehicle sensor(s) 96 and/or the implement sensor(s) 98, to determine the required operational status of the agricultural vehicle 10. For example, the computing system 118 may determine a minimum required operational status (e.g., engine speed and/or torque load of the engine 104) to, for example, avoid a stall of the agricultural vehicle 10 or maintain a ground speed of the agricultural vehicle 10. In this respect, the computing system 118 may determine what combination of incline slope and draft load of the agricultural implement 70 are required such that the agricultural vehicle 10 would experience a stall at a particular operational status (e.g., engine speed and/or torque load of the engine 104), and then determine, for example, the required engine speed and/or torque load necessary to, for example, avoid a stall and/or maintain the engine speed for the particular combination of incline slope and draft load of the agricultural implement 70. For instance, the computing system 118 may access a look-up table within its memory 126 that correlates the determined draft load of the implement 70 and the determined field surface incline parameter (e.g., slope) to the corresponding required operational status of the agricultural vehicle 10 to, for example, avoid a stall and/or maintain the engine speed of the agricultural vehicle 70. Moreover, the computing system 118 may be configured to determine the required operational status of the agricultural vehicle 10 prior to the agricultural vehicle 10 and/or the agricultural implement 70 engaging the field surface incline.

Additionally, as shown in FIG. 4, at (214), the control logic 200 includes initiating an adjustment to at least one of the engine or the transmission to adjust the current operational status to the required operational status of the agricultural vehicle prior to engagement of the field surface incline. For example, as mentioned previously in reference to FIG. 3, the computing system 118 is configured to control the operation of one or more components of the agricultural vehicle 10, such as the engine 104 and the transmission 106. As such, the computing system 118 is configured to adjust the current operational status of the agricultural vehicle 10 (e.g., output of the engine 104 such as engine speed and/or torque output) determined at (210) to match the required operational status of the agricultural vehicle 10 determined at (212). Finally, the control logic returns to (202).

Referring now to FIG. 5, a flow diagram of one embodiment of a method 300 for controlling the operation of an agricultural vehicle is illustrated in accordance with aspects of the present subject matter. In general, the method 300 will be described herein with reference to the system 100 described above with reference to FIG. 3 and the control logic 200 described above with reference to FIG. 4. However, it should be appreciated by those of ordinary skill in the art that the disclosed method 300 may be implemented within any other system having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 includes determining a field surface incline parameter based on data generated by a sensor configured to generate data indicative of a field surface incline forward of the agricultural vehicle relative to a direction of travel of the agricultural vehicle. For example, as indicated above, the computing system 118 may be configured to determine the field surface incline parameter based on the data generated by the sensor configured to generate data indicative of the field surface incline forward of the agricultural vehicle 10 relative to the direction of travel of the agricultural vehicle 10.

Additionally, at (304), the method 300 includes initiating an adjustment to an operation of at least one of an engine or a transmission of the agricultural vehicle based on the determined field surface incline parameter prior to engagement of the field surface incline. For example, as indicated above, the computing system 118 may be configured to initiate an adjustment to an operation of at least one of the engine 104 or the transmission 106 of the agricultural vehicle 10 based on the determined field surface incline parameter prior to engagement of the field surface incline.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An agricultural vehicle configured to tow an agricultural implement, the agricultural vehicle comprising:
a frame;
an engine coupled to the frame;
a transmission operatively coupled to the engine;
a sensor configured to generate data indicative of a field surface incline forward of the agricultural vehicle relative to a direction of travel of the agricultural vehicle; and
a computing system communicatively coupled to the sensor, the computing system configured to:
determine a field surface incline parameter based on the data generated by the sensor; and
initiate an adjustment to an operation of at least one of the engine or the transmission based on the determined field surface incline parameter prior to engagement of the field surface incline.

2. The agricultural vehicle of claim 1, wherein the sensor corresponds to a first sensor, the agricultural vehicle further comprising:
a second sensor configured to generate data indicative of a draft load of the agricultural implement,
wherein the computing system is communicatively coupled to the second sensor, the computing system being further configured to:
determine the draft load of the agricultural implement based on the data received from the second sensor; and
initiate an adjustment to the operation of at least one of the engine or the transmission based on the determined draft load of the agricultural implement prior to engagement of the field surface incline.

3. The agricultural vehicle of claim 2, wherein the computing system being further configured to:
determine a current operational status of the agricultural vehicle; and
initiate an adjustment to the operation of at least one of the engine or the transmission based on the determined current operational status of the agricultural vehicle prior to engagement of the field surface incline.

4. The agricultural vehicle of claim 3, wherein the computing system being further configured to:
determine a required operational status of the agricultural vehicle based on the determined draft load of the agricultural implement and the determined field surface incline parameter; and
initiate an adjustment to an operation of at least one of the engine or the transmission so as to adjust the determined current operational status to the determined required operational status of the agricultural vehicle prior to engagement of the field surface incline.

5. The agricultural vehicle of claim 1, wherein the field surface incline parameter comprises a slope of the field surface incline.

6. A system for controlling an operation of an agricultural vehicle configured to tow an agricultural implement, the system comprising:
an engine coupled to a frame of the agricultural vehicle;
a transmission operatively coupled to the engine;
a sensor configured to generate data indicative of a field surface incline forward of the agricultural vehicle relative to a direction of travel of the agricultural vehicle; and
a computing system communicatively coupled to the sensor, the computing system configured to:
determine a field surface incline parameter based on the data generated by the sensor; and
initiate an adjustment to an operation of at least one of the engine or the transmission based on the determined field surface incline parameter prior to engagement of the field surface incline.

7. The system of claim 6, wherein the sensor corresponds to a first sensor, the system further comprising:
a second sensor configured to generate data indicative of a draft load of the agricultural implement,
wherein, the computing system being further configured to:
determine the draft load of the agricultural implement based on the data received from the second sensor; and
initiate an adjustment to the operation of at least one of the engine or the transmission based on the determined draft load of the agricultural implement prior to engagement of the field surface incline.

8. The system of claim 7, wherein the computing system being further configured to:
determine a current operational status of the agricultural vehicle; and
initiate an adjustment to the operation of at least one of the engine or the transmission based on the determined current operational status of the agricultural vehicle prior to engagement of the field surface incline.

9. The system of claim 8, wherein the computing system being further configured to:
determine a required operational status of the agricultural vehicle based on the determined draft load of the agricultural implement and the determined field surface incline parameter; and
initiate an adjustment to at least one of the engine or the transmission so as to adjust the determined current operational status to the determined required operational status of the agricultural vehicle prior to engagement of the field surface incline.

10. The system of claim 9, wherein determining a required operational status of the agricultural vehicle based on the determined draft load of the agricultural implement and the determined field surface incline parameter comprises determining a minimum required operational status to avoid a stall of the agricultural vehicle.

11. The system of claim 6, wherein the field surface incline parameter comprises a slope of the field surface incline.

12. The system of claim 6, wherein initiating an adjustment to an operation of at least one of the engine or the transmission comprises initiating an adjustment to a gear ratio of the transmission.

13. The system of claim 6, wherein initiating an adjustment to an operation of at least one of the engine or the transmission comprises initiating an adjustment of an output of the engine.

14. A method for controlling an operation of an agricultural vehicle configured to tow an agricultural implement, the method comprising:
determining, with a computing system, a field surface incline parameter based on data generated by a sensor configured to generate data indicative of a field surface incline forward of the agricultural vehicle relative to a direction of travel of the agricultural vehicle; and
initiating, with the computing system, an adjustment to an operation of at least one of an engine or a transmission of the agricultural vehicle based on the determined field surface incline parameter prior to engagement of the field surface incline.

15. The method of claim 14, wherein the sensor corresponds to a first sensor, the method further comprising:
determining, with the computing system, a draft load of the agricultural implement based on the data received from a second sensor configured to generate data indicative of the draft load of the agricultural implement; and
initiating, with the computing system, an adjustment to the operation of at least one of the engine or the transmission of the agricultural vehicle based on the determined draft load of the agricultural implement prior to engagement of the field surface incline.

16. The method of claim 15, further comprising:
determining, with the computing system, a current operational status of the agricultural vehicle; and
initiating, with the computing system, an adjustment to the operation of at least one of the engine or the transmission of the agricultural vehicle based on the determined current operational status prior to engagement of the field surface incline.

17. The method of claim 16, further comprising:
determining, with the computing system, a required operational status of the agricultural vehicle based on the determined draft load of the agricultural implement and the determined field surface incline parameter; and
initiating, with the computing system, an adjustment to an operation of at least one of the engine or the transmission so as to adjust the current operational status of the agricultural vehicle to the required operational status of the agricultural vehicle prior to engagement of the field surface incline.

18. The method of claim 17, wherein determining, with the computing system, a required operational status of the agricultural vehicle based on the determined draft load of the agricultural implement and the determined field surface incline parameter comprises determining, with the computing system, a minimum required operational status to avoid a stall of the agricultural vehicle.

19. The method of claim 14, wherein initiating, with the computing system, an adjustment to an operation of at least one of the engine or the transmission comprises initiating, with the computing system, an adjustment to a gear ratio of the transmission.

20. The method of claim 14, wherein initiating, with the computing system, an adjustment to an operation of at least one of the engine or the transmission comprises initiating, with the computing system, an adjustment of an output of the engine.
